(19) United States
(12) Patent Application Publication
(10) Pub. No.: US 2026/0172729 A1
(43) Pub. Date: Jun. 18, 2026

(54) Headphones

(71) Applicant: USOUND GMBH, Graz (AT)

(72) Inventors: Andrea Rusconi Clerici Beltrami, Wien (AT); Ferruccio Bottoni, Graz (AT)

(21) Appl. No.: 19/423,009

(22) Filed: Dec. 17, 2025

(30) Foreign Application Priority Data
Dec. 18, 2024 (DE) 10 2024 138 740.8
Nov. 13, 2025 (DE) 10 2025 147 004.9

(51) Int. Cl. H04R 1/02; H04R 1/10

(52) U.S. Cl. CPC H04R 1/028; H04R 1/1041; H04R 2201/003

(57) ABSTRACT

The invention relates to headphones (1), in particular on-ear headphones, over-ear headphones, and/or in-ear headphones, comprising at least one sound transducer (2) for generating and detecting at least ultrasonic waves (3), and comprising a control unit (4) which can determine a bodily function, in particular a cardiac function and/or a respiratory function, of a wearer (5) of the headphones (1) on the basis of the generated and detected ultrasonic waves (3). Furthermore, the at least one sound transducer (2) is a MEMS sound transducer (2), in particular a broadband MEMS sound transducer. The invention also relates to a method for determining a bodily function, in particular a cardiac function and/or a respiratory function, of a wearer (5) of headphones (1), in particular on-ear headphones, over-ear headphones, and/or in-ear headphones, wherein ultrasonic waves (3) are generated by means of a MEMS sound transducer (2), in particular a broadband MEMS sound transducer, of the headphones (1), wherein the ultrasonic waves (3) are detected by means of the MEMS sound transducer (2), in particular the broadband MEMS sound transducer, and/or a further microphone, and wherein the bodily function of the wearer (5) of the headphones (1) is determined by means of a control unit (4) of the headphones (1) on the basis of the generated and detected ultrasonic waves (3), and to an, in particular broadband, MEMS sound transducer (2) for headphones (1) and/or to a method for determining a bodily function.

The present invention relates to headphones, in particular on-ear headphones, over-ear headphones, and/or in-ear headphones, having at least one sound transducer for generating and detecting at least ultrasonic waves, and having a control unit which can determine at least one feature, in particular a bodily function, preferably a cardiac function and/or a respiratory function, and/or an identity, of a wearer of the headphones, and/or carry out an authentication of the wearer, on the basis of the generated and detected ultrasonic waves.

The object of the present invention is to provide headphones with which features of the wearer can be determined reliably, with high measurement quality, and/or in a manner which is gentle on the ear.

The object is achieved by means of headphones, a method, and/or the use of a MEMS sound transducer having the features of the independent claims. Advantageous or preferred embodiments are each the subject matter of a corresponding dependent claim.

The invention relates to headphones. The headphones can be on-ear headphones, over-ear headphones, and/or in-ear headphones. On-ear headphones and over-ear headphones are worn over the ears. In-ear headphones are headphones that are inserted at least partially into the ear canal of a user or wearer.

The headphones include at least one sound transducer for generating and detecting at least ultrasonic waves.

Furthermore, the headphones include a control unit which can determine at least one feature, in particular a bodily function, preferably a cardiac function and/or a respiratory function, and/or an identity, of a wearer of the headphones, and/or carry out an authentication of the wearer, on the basis of the generated and detected ultrasonic waves. The headphones can therefore be used to determine vital functions of the wearer, such as their heart rate and/or respiration rate. Additionally or alternatively, the wearer can be identified with the aid of the headphones. In the following, the invention can be explained primarily with reference to the measurement of the bodily function. Additionally or alternatively, the identity of the wearer can also be determined. Additionally or alternatively, the authentication of the wearer can also be carried out.

The at least one sound transducer is a MEMS sound transducer which can generate at least ultrasonic waves in a broadband spectrum. The MEMS sound transducer can be a broadband MEMS sound transducer. Additionally or alternatively, the MEMS sound transducer can be a broadband MEMS sound transducer. Additionally or alternatively, the MEMS sound transducer can be a MEMS broadband sound transducer. Additionally or alternatively, the MEMS sound transducer can be a MEMS broadband ultrasonic transducer. Additionally or alternatively, the MEMS sound transducer can be a MEMS broadband ultrasonic loudspeaker. In the following, for the sake of simplicity, only a MEMS sound transducer can be discussed, even though it is a MEMS broadband sound transducer, a MEMS broadband ultrasonic transducer, and/or a MEMS broadband ultrasonic loudspeaker, etc.

Since the broadband spectrum can be generated by means of the MEMS sound transducer, a plurality of possible ultrasonic waves having different frequencies or measurement frequencies is available for measuring the bodily function. The MEMS sound transducer is capable of generating different ultrasonic waves with different frequencies of the broadband spectrum, such that different measurement frequencies of the ultrasonic waves are available. During the measurement of the bodily function, the ultrasonic waves are emitted and then interact with the tissue, the ear, the ear canal, etc. The ultrasonic waves which have been changed as a result, or the reflected ultrasonic waves, are detected once again and evaluated, thereby determining the bodily function. The MEMS sound transducer offers the possibility to measure the bodily function using various ultrasonic frequencies. The MEMS sound transducer can generate high-quality ultrasonic waves over the entire broadband spectrum for measuring the bodily function.

Due to the use of the MEMS sound transducer, which can generate the ultrasonic waves over the broadband spectrum, i.e. with the aid of a broadband MEMS sound transducer, it is possible to achieve improved resolution, accuracy of the measurement, and/or a high-quality and/or reliable measurement of the bodily function. Due to the ability to generate the ultrasonic waves over the broadband spectrum, i.e. the possibility that the MEMS sound transducer can generate ultrasonic waves with different frequencies from the broadband spectrum, the measurement frequency of the emitted ultrasonic waves can be individually adapted to the ear canal, or to the ear, or to the wearer. Since the ear canals and the ears of different wearers differ from one another, it can be advantageous for a reliable measurement of the bodily function to select another frequency, i.e. a frequency of the ultrasonic waves adapted to the specific ear canal, the ear, or the wearer. Which frequency of the ultrasonic waves is used to measure the bodily function also depends on how and where the headphones are worn. With on-ear headphones or over-ear headphones, for example, other frequencies can be more advantageous than with in-ear headphones.

With the aid of the MEMS sound transducer which can generate the ultrasonic waves from the broadband spectrum, the measurement of the bodily function can also be reliably carried out for different wearers having different ear canals or ears. The MEMS sound transducer can generate the ultrasonic waves from the broadband spectrum and over the broadband spectrum with high quality. The MEMS sound transducer can provide a plurality of frequencies, or all frequencies, from the broadband spectrum, which can be used to measure the individual bodily function.

It is advantageous when the MEMS loudspeaker can generate the broadband spectrum having an audible wavelength spectrum and an ultrasonic spectrum, such that the sound waves that can be generated are audible sound waves and ultrasonic waves. These sound waves from the broadband spectrum that are generatable by the MEMS sound transducer can be in a frequency range that is greater than or equal to 3 kHz, 4 kHz, or 15 kHz to less than or equal to 40 kHz, 80 kHz, or 100 kHz. A broadband loudspeaker that can generate sound in the audible range and in the ultrasonic range offers the advantage of broader frequency coverage. This variety of frequencies from, for example, 3 kHz to 100 kHz, makes it possible, on the one hand, to generate audible sound waves, such that, for example, music can be listened to using the headphones. On the other hand, due to the MEMS sound transducer, the ultrasonic waves from the broadband spectrum, for example, up to 100 kHz, can be generated for measuring the bodily function. Furthermore, as a result, the information content of the measurement can be increased, since a greater frequency range is available. It is possible to generate ultrasonic waves having different measurement frequencies from the broadband spectrum, with which different measurements can be carried out.

Furthermore, it is advantageous when the control unit and/or the MEMS loudspeaker is designed and/or set up in such a way that, for determining the bodily function, a measurement signal is generatable from ultrasonic waves having at least one measurement frequency the broadband spectrum. With the aid of the measurement signal, the measurement of the bodily function can be carried out. The measurement signal is emitted, interacts with the ear, for example the tissue and/or the ear canal, and returns as reflected ultrasonic waves, wherein the reflected ultrasonic waves are detected. The bodily function can be determined on the basis of a comparison between the emitted measurement signal and the detected, reflected ultrasonic waves.

The measurement signal can have one or more measurement frequencies that originate from the broadband spectrum which is generatable by the MEMS sound transducer.

It is advantageous when the control unit and/or the MEMS loudspeaker is designed and/or set up in such a way that the ultrasonic waves of the measurement signal generated by the MEMS sound transducer include one or more, in particular discrete, measurement frequencies. The broadband spectrum has one or more peaks, or measurement frequency peaks, which are represented by the one measurement signal or the plurality of measurement signals. The measurement signals are characterized by individual frequencies that are very narrow in the broadband spectrum. The evaluation can be facilitated by the clearly defined peaks of the measurement signals, since the reflected ultrasonic waves can be easily compared to the measurement signals and to the measurement frequency peaks. Furthermore, as a result, a high signal-to-noise ratio can be achieved and undesirable disturbance frequencies can be more easily suppressed, which results in higher measurement accuracy.

It is furthermore advantageous when the ultrasonic waves of the measurement signal include continuous measurement frequencies, such that the measurement signal has a broad measurement frequency spectrum in the broadband spectrum. A broad measurement frequency spectrum offers the advantage that a larger amount of information regarding the reflected signals can be collected. This results in a more detailed analysis. In addition, a continuous and broad measurement frequency spectrum can be used to measure the bodily function of a broad spectrum of different wearers. An adaptation of the measurement frequency to a specific ear shape is eliminated.

The discrete measurement frequencies, i.e. the measurement signal having at least one measurement frequency peak, can be advantageous for isolating a specific/certain signal range for the analysis and thus for improving the detection of patterns or changes in the signal. Due to the continuous measurement frequency spectrum, comprehensive and information-rich data acquisition is possible in order to more accurately analyze complex reflections and interactions.

The advantage of the discrete measurement frequencies is that sharp peaks in the frequency range facilitate the evaluation. The advantage of the continuous spectrum is that it enables a detailed analysis of complex signals to be carried out, in that it utilizes the larger ranges of the broadband spectrum.

It is advantageous when the control unit and/or the MEMS loudspeaker is designed and/or set up in such a way that the at least one measurement frequency peak of the measurement signal has a width of less than 3 kHz, 2 kHz, or 1 kHz. Due to the small width of the measurement frequency peak, a precise frequency selection is made possible, which facilitates the suppression and/or detection of disturbances and undesirable signal components. This results in greater accuracy of the analysis and improves the overall signal quality, since the relevant frequency band is detected more clearly and in a more defined manner. The measurement signal is very narrow-band but originates from the broadband spectrum. The measurement signal having the measurement frequency peaks can be, for example, between 3 kHz and 100 kHz. For example, a measurement signal can be generated from the MEMS sound transducer with a measurement frequency peak at 30 kHz and a width of 2 kHz.

A narrow-band design of the measurement frequency peak optimizes the sensitivity for fine changes and/or patterns in the target signal or the reflected ultrasonic waves. At the same time, this focusing reduces the complexity of the signal processing, since there is less irrelevant data to take into account, which reduces the susceptibility to error and makes the measurement more reliable.

Moreover, it is advantageous when the control unit and/or the MEMS sound transducer is designed and/or set up in such a way that the measurement frequency spectrum of the measurement signal has a frequency width of greater than or equal to 1 kHz or greater than or equal to 5 kHz or greater than or equal to 10 kHz or greater than or equal to 20 kHz or greater than or equal to 30 kHz or greater than or equal to 40 kHz or greater than or equal to 50 kHz or greater than or equal to 60 kHz or greater than or equal to 70 kHz or greater than or equal to 80 kHz. Additionally or alternatively, the measurement frequency spectrum of the measurement signal can have a frequency width of less than 70 kHz or less than 60 kHz or less than 50 kHz or less than 40 kHz or less than 30 kHz or less than 20 kHz or less than 10 kHz. The upper limit is always greater than the lower limit, of course. For example, the measurement frequency spectrum of the measurement signal can have a frequency width from 30 kHz to 55 kHz. The frequency width in this case is 25 kHz. With the aid of a large frequency width, furthermore, more information can be collected, or measured, since more frequencies are available for the measurement.

Advantageously, the MEMS sound transducer is designed and/or set up in such a way that the sound waves generatable in the broadband spectrum have a sound pressure level of greater than or equal to 50 dB, preferably greater than or equal to 55 dB, particularly preferably greater than or equal to 70 dB. Furthermore, these sound pressure levels are gentle on the ear and/or the tissue.

According to one advantageous enhanced embodiment of the invention, the MEMS sound transducer is designed and/or set up in such a way that the sound waves generatable in the broadband spectrum have a sound pressure level of less than or equal to 90 dB, preferably less than or equal to 85 dB, particularly preferably less than or equal to 80 dB. The delimitation of the sound pressure level reduces the load on the hearing and increases the comfort for the wearer during the continuous monitoring. This is particularly important for long-term use. Due to this sound pressure level, the ear and/or the tissue is not damaged.

Furthermore, it is advantageous when the MEMS sound transducer is designed and/or set up in such a way that the sound waves generatable in the broadband spectrum have a sound pressure level, in particular over the entire broadband spectrum, having a deviation of +/−10 dB, in particular +/−5 dB, about an average value. A low deviation of the sound pressure level ensures a high precision of the measurement, which improves the reliability of the monitoring of the bodily function. In particular, the measurement frequency spectrum of the measurement signal can have this deviation over its entire frequency width.

Moreover, it is advantageous when the MEMS sound transducer is designed and/or set up in such a way that the sound waves generatable in the broadband spectrum, in particular over the entire broadband spectrum, have a continuous spectrum. The MEMS sound transducer can therefore form all frequencies in the broadband spectrum, for example from 3 kHz to 100 kHz, such that, on the one hand, audible sound waves can be generated. On the other hand, all ultrasonic waves, for example up to 100 kHz, are therefore available for measuring the bodily functions. Consequently, a plurality of frequencies is available for the measurement.

It is advantageous when the headphones and/or the control unit includes a modulator, which can combine and/or modulate an electrical signal that corresponds to the audible sound waves and an electrical signal that corresponds to the measurement signal in the ultrasonic range. As a result, it becomes possible to efficiently output both signal types using the same MEMS sound transducer, which generates sound waves in the audible frequency range and in the ultrasonic range from the modulated signal. As a result, the audible sound waves and the ultrasonic waves can be generated by the MEMS sound transducer at the same time and/or simultaneously. This integration reduces the complexity of the system, since separate sound transducers for the two frequency ranges are not required. At the same time, the amount of space required is minimized, which is advantageous in particular for compact devices such as headphones. In addition, the modulation makes it possible to precisely control the signal combination, whereby the quality and efficiency of the generated sound waves are improved. This offers versatile usability in different applications such as audio output and monitoring vitality data.

It is advantageous when the headphones and/or the control unit includes a signal generator which can generate discrete-time pulses, chirp signals, sweep signals, and/or multitone signals for generating the ultrasonic waves for determining the bodily function. The use of chirp signals and sweep signals makes it possible to effectively analyze the tissue reflections and improves the measurement accuracy due to greater frequency coverage.

With the aid of these signals, the ultrasound, in particular with the continuous spectrum, can be generated.

It is advantageous when the headphones include an MLS signal generator by means of which a maximum-length-sequence signal can be generated, on the basis of which the MEMS sound transducer can generate at least the ultrasonic waves in the broadband spectrum. It is advantageous when the signal generator includes the MLS signal generator or is the MLS signal generator. The signal generator can therefore also generate the maximum-length-sequence signal in addition to or alternatively to the discrete-time pulses, chirp signals, sweep signals, and/or multitone signals for generating the ultrasonic waves.

The maximum-length-sequence (MLS) signal can be used to carry out the measurement or to carry out the method by means of the headphones. An MLS signal is understood to be a pseudorandom bitstream, the spectral energy density of which is evenly distributed over a broad frequency range and the autocorrelation of which corresponds to a narrow pulse. As a result, all frequencies in the frequency range can be excited at the same time, which makes it possible to completely determine the acoustic pulse response of the ear canal. The technical advantage is the uniform spectral excitation and the possibility to determine the transmission behavior of the ear without prior calibration.

According to the method, the ultrasonic waves generated from the MLS signal are emitted into the ear canal by means of the sound transducer unit, for example by means of the MEMS sound transducer unit. The echo signal reflected in the ear, or the reflected ultrasonic waves, can be received by the same sound transducer unit or by a further sound transducer unit. Features of the user can be determined by evaluating the ratios of propagation time and amplitude between transmitted signal and echo signal.

The MLS signal is generated in digital form and then filtered. The filtering is used to adapt the frequency range of the signal to the particular measurement scenario, in particular by removing audible frequencies and shifting the usable range into the ultrasonic range. The resulting waveform has a uniform energy distribution over the desired frequencies, whereby intermodulation distortions are distributed across a wide band and thus become non-critical to the measurement.

After the filtering, the signal is converted into an electrical transmitted signal by means of a digital-to-analog converter and output to the sound transducer unit. The acoustic echo signal that has been changed due to reflection and absorption in the ear is digitized via an analog-to-digital converter and fed to a processor. By determining a cross-correlation between transmitted signal and reception signal, the pulse response of the system can be determined. This includes all acoustic properties of the ear canal and forms the basis for determining physiological parameters.

A processor and/or the control unit can additionally carry out spectral analyses, such as Fourier analyses, wavelet analyses, or periodogram analyses, in order to determine time-varying properties of the pulse response or of the frequency response. Additionally or alternatively, a cepstrum analysis can also be carried out by the processor and/or the control unit. In this way, the slightest changes in the acoustic behavior of the ear can be detected, which changes are caused, for example, by pulsation, breathing, or head motions. With the aid of the cepstrum analysis, for example, the wearer can be identified particularly well.

The processor mentioned here can be the control unit. Alternatively, the control unit can include the processor.

A particular advantage of the invention is that the measurement can be carried out regardless of the geometric shape of the ear canal, the exact position of the headphones, and a prior calibration to a specific measurement frequency associated with the wearer. Since the MLS signal excites all frequencies in the frequency range at the same time, anatomical differences are automatically taken into account, whereby an individual calibration is not required.

Due to the use of one single sound transducer unit, which is operated as loudspeaker and microphone in alternation, the overall size of the system can be reduced and high measurement accuracy can be achieved. At the same time, the integration into commercially available headphones enables use that is inconspicuous and permanent. The invention therefore provides a robust, broadband, and calibration-free measuring method for determining individual or physiological features of a user using acoustic signals in the ultrasonic range.

It is advantageous when the maximum-length-sequence signal is generated by means of an MLS signal generator. An MLS signal generator typically implements a linear-feedback shift register, which generates a defined bitstream having a maximum period length. As a result, the waveform is exactly reproducible, which creates a precise reference for the cross-correlation with the echo signal.

It is advantageous when the maximum-length-sequence signal is generated by means of a linear feedback-shift register having a period length of 2\hat{ }n−1, wherein the number of bits n of the shift register is in a range from 8 to 16. A greater n value results in a finer frequency resolution and a higher signal-to-noise ratio.

Advantageously, generated ultrasound is generated and/or processed with a scanning rate between 50 kHz and 200 kHz, in particular with 96 kHz. The scanning rate establishes the highest measurable frequency (Nyquist limit) and the time resolution of the measurement. With 96 kHz, the ultrasonic range up to 48 kHz is covered, which permits precise detection of the ear acoustics over the hearing range.

In an advantageous enhanced embodiment of the invention, the maximum-length-sequence signal generated by the MLS signal generator is filtered by at least one filter unit. This yields a digital transmitted signal which generates the ultrasound. Filtering is understood to mean the frequency-selective adaptation of the signal in order to suppress undesirable frequencies. By means of digital filtering, audible frequencies can be removed and the spectral form of the signal can be adapted to the purpose of the measurement. Therefore, an acoustic transmitted signal, i.e. the ultrasound, is generated, which lies entirely within the ultrasonic range, such that the user is not disturbed by the measurement.

It is advantageous when the at least one filter unit carries out a broadband limitation, wherein, in particular, frequences in the audible range are removed. This prevents acoustic perceptibility of the measurement signal by the user and reduces disturbing interferences with playback signals.

Moreover, it is advantageous when the at least one filter unit carries out a predistortion. A predistortion compensates for the frequency-dependent sensitivity of loudspeaker and microphone. As a result, the overall transmission function is linearized, which increases the quality of the reconstructed pulse response.

The filter unit is preferably designed as a digital filter device that processes the data signal generated from the maximum-length-sequence signal in real time. The filter unit can be designed as a software module within the processing unit or control unit, or as a standalone hardware component. The signal processing is preferably carried out by means of digital filter structures, in particular Butterworth filters and biquad filters, which are particularly suitable for embedded systems due to their stability and computational efficiency. The filter parameters can be dynamically adapted to the particular measurement scenario in order to precisely delimit the usable frequency range, for example the ultrasonic range, between 20 kHz and 75 kHz. Due to the digital implementation of the filter unit, reproducible and low-loss signal shaping is made possible, whereby it is ensured that the transmitted signal has a constant spectral energy density over the desired frequency range.

In a preferred embodiment, the filter unit includes a combination of high-pass filters, low-pass filters, and/or band-pass filters, which can be connected in cascade or in parallel. As a result, the maximum-length-sequence signal can be specifically adapted in such a way that disturbing low-frequency components and undesirable harmonic components are suppressed. Due to the use of Butterworth filters with maximum flat amplitude characteristics in the passband range, the phase angle of the MLS signal is only minimally influenced, which is essential for the later cross-correlation and pulse-response determination. Biquad filter structures additionally allow a flexible adaption of the edge steepness and damping, whereby the filter behavior can be optimally adapted to the electroacoustical properties of the sound transducer unit that is used. In this way, the filter unit makes a substantial contribution to the linearity and accuracy of the overall measurement method.

It is advantageous when the MEMS sound transducer includes at least one piezoelectric element and a diaphragm coupled to the at least one piezoelectric element, wherein the at least one piezoelectric element and the diaphragm are coupled together by means of an amplification plate, such that the diaphragm can be deflected in a planar manner to generate the ultrasonic waves. The arrangement of the piezoelectric element with the diaphragm enables efficient generation of high-frequency ultrasonic waves, which contributes to the improvement of the signal quality and to precise detection. With the aid of the planar coupling of the diaphragm to the at least one piezoelectric element via the amplification plate, a highly constant ultrasound having a continuous spectrum in the frequency range can be generated.

According to one advantageous enhanced embodiment of the invention, the MEMS sound transducer is arranged in such a way that, when the headphones are used as intended, the ultrasonic waves are emitted into an ear canal of the wearer. The direct emission into the ear canal ensures increased signal quality and makes it possible to precisely detect the vital parameters by means of a specific reflectance measurement in the ear canal. It is advantageous when the ultrasonic waves can be generated and detected using the same MEMS sound transducer. Additionally or alternatively, the headphones can include a microphone and/or a further MEMS sound transducer, by means of which the ultrasonic waves generated by the MEMS sound transducer can be detected.

The invention also relates to a method for determining a bodily function, in particular a cardiac function and/or a respiratory function, of a wearer of headphones, in particular of on-ear headphones, over-ear headphones, and/or in-ear headphones. The headphones can have at least one feature according to the preceding description and/or the following description. Furthermore, at least one feature according to the preceding description and/or the following description can be used in the method according to its properties and/or determination.

In the method, ultrasonic waves are generated from a broadband spectrum by means of a MEMS sound transducer, in particular a broadband MEMS sound transducer, of the headphones. The ultrasonic waves are used to measure the bodily function. The ultrasonic waves originate from a broadband spectrum, wherein the MEMS sound transducer can generate these ultrasonic waves from the broadband spectrum. As a result, a plurality of possible frequencies of the ultrasonic waves is available for measuring the bodily function.

In the method, the ultrasonic waves are detected by means of the MEMS sound transducer, in particular the broadband MEMS sound transducer, and/or a further microphone.

In addition, the bodily function of the wearer of the headphones is determined on the basis of the generated and detected ultrasonic waves by means of a control unit of the headphones.

It is advantageous when a measurement signal having one or a plurality of measurement frequencies from the generatable broadband spectrum is emitted by means of the MEMS sound transducer in order to determine a bodily function. This makes it possible to flexibly select the measurement frequencies within the broadband spectrum, whereby specific requirements on the analysis and detection of the bodily function can be met. In addition, different frequencies can be used to adapt the signal quality to different anatomical and physical conditions, which increases the robustness and versatility of the system.

It is advantageous when at least one measurement signal is generated, the ultrasonic waves of which have one or a plurality of measurement frequency peaks in a broadband spectrum. The generation of measurement frequency peaks makes it possible to carry out a specific analysis, whereby disturbances are minimized and the signal quality can be improved. As a result, the signal-to-noise ratio can be improved, since a narrow-band measurement signal is emitted and disturbances, or background noise, can be easily detected. This is helpful for reliably and efficiently detecting certain patterns or changes in the reflected signals. Furthermore, an emitted measurement signal having one or a plurality of measurement frequency peaks in the broadband spectrum generates reflected signals that also have a sharp peak. The evaluation is simplified as a result.

Additionally or alternatively, it is advantageous when a measurement signal is generated, the ultrasonic waves of which include a measurement frequency spectrum, in particular a continuous measurement frequency spectrum, in the broadband spectrum. A continuous measurement frequency spectrum offers the advantage that a broader database is created, which makes a more comprehensive analysis possible. Multiple frequencies are simultaneously emitted at the same time as the measurement, such that multiple measurements can be carried out at the same time. Due to the use of the entire broadband spectrum, complex reflections and interactions of the ultrasonic waves with tissue or surfaces can be detected with greater detail, which increases the versatility and adaptability of the system for different applications. Due to the broad measurement frequency spectrum in the broadband spectrum, the measurement frequency that delivers the best measurement results is also automatically included.

Advantageously, the control unit, or the processor, carries out a Fourier analysis, a wavelet analysis, or a periodogram analysis prior to the determination of the at least one feature. Additionally or alternatively, the processor can carry out a cepstrum analysis in order to determine the at least one feature. Additionally or alternatively, these analyses can be also carried out individually or in combination for the authentication. These analyses are used to transform the echo signal into the frequency range, whereby spectral changes can be identified. Thus, resonance shifts or damping changes that include physiological information can be detected.

It is advantageous when the control unit runs a search program and/or a search algorithm with which a measurement frequency matching a wearer of the headphones is determined. Due to this adaptation to the individual conditions of the wearer, such as the specific anatomy of the ear canal and/or individual tissue properties, optimal signal quality and measurement accuracy are obtained. This function makes it possible to dynamically and/or automatically adapt and/or optimize the measurement frequency of the measurement signal to the wearer, whereby the reliability of the detection of the bodily functions, such as the heart rate or respiration rate, can be increased. In addition, the wearing comfort is improved, since a manual calibration or adaptation is not required, which simplifies the operation of the system for the user and ensures consistent performance. For example, the search program and/or the search algorithm can be run in such a way that the control unit tries out multiple measurement frequencies and then selects the one that delivers the best results. For example, the control unit can try out all measurement frequencies from 20 kHz to 100 kHz in increments of 1 kHz.

Moreover, it is advantageous when ultrasonic waves are generated, in the broadband spectrum of which, at least one measurement frequency peak of the measurement signal has a width of less than 3 kHz, 2 kHz, or 1 kHz. As a result, the measurement signals are sufficiently narrow-band, although they originate from the broadband spectrum generatable by the MEMS sound transducer. Due to the sharp measurement signal, the evaluation can be simplified, since the reflected ultrasonic waves also have a narrow-band spectrum.

Additionally or alternatively, the ultrasonic waves can be generated, the measurement frequency spectrum of which has a frequency width of greater than 5 kHz, 10 kHz, 20 kHz, 30 kHz, 40 kHz, 50 kHz, 60 kHz, 70 kHz, or 80 kHz, and/or of less than 80 kHz or less than 70 kHz or less than 60 kHz or less than 50 kHz or less than 40 kHz or less than 30 kHz or less than 20 kHz or less than 10 kHz or less than 5 kHz. The upper limit is greater than the lower limit. As a result, more information can be collected in the measurement, since a plurality of frequencies is emitted at the same time, or the broad measurement signal according to the broad measurement frequency spectrum is emitted for measurement purposes.

Advantageously, ultrasonic waves are generated, which have a sound pressure level of greater than or equal to 50 dB, preferably greater than or equal to 55 dB, particularly preferably greater than or equal to 70 dB. A uniform and sufficiently high sound pressure level ensures robust signal quality and makes a precise analysis possible, even at a low signal-to-noise ratio.

It is advantageous when ultrasonic waves are generated, which have a sound pressure level of less than or equal to 90 dB, preferably less than or equal to 85 dB, particularly preferably less than or equal to 80 dB. The delimitation of the sound pressure level minimizes the load on the hearing and increases the wearing comfort, which supports the continuous monitoring. With the aid of a sound pressure level in the range of approximately between 50 dB and 90 dB, the measurement can be even more reliably carried out without the ear and/or the tissue becoming damaged.

Advantageously, the sound pressure level has a deviation of +/−10 dB, in particular of +/−5 dB, about an average value, in particular over the entire frequency width of the measurement frequency spectrum. A low deviation of the sound pressure level ensures a stable and reliable measuring environment for monitoring the vital parameters.

Moreover, it is advantageous when ultrasonic waves are generated, which have a continuous spectrum in the measurement frequency spectrum, in particular over its entire frequency width. A continuous spectrum permits a high information density and increases the evaluation possibilities, whereby more precise and more consistent measurement results are obtained. Due to the continuous spectrum, in contrast to a discrete spectrum, a plurality of frequencies is available for measurement purposes.

It is advantageous when the ultrasonic waves are generated by means of a signal generator. The use of a signal generator makes it possible to precisely control and optimize the ultrasonic signals and thus improves the measurement quality.

It is advantageous when, in order to generate audible sound waves and ultrasonic waves, the corresponding electrical signals are combined and/or modulated by means of a modulator, wherein this modulated signal is then transmitted to the MEMS sound transducer for conversion. This combination of the signals enables the MEMS sound transducer to be used efficiently, which MEMS sound transducer can thus generate both frequency ranges, i.e. the audible sound waves and the ultrasonic waves, at the same time.

It is advantageous when the measurement signals are emitted in time intervals between 30 μs and 300 ms, in particular between 1 μs and 100 ms.

This emission of the measurement signals in time intervals makes it possible to flexibly adapt to the specific requirements of the application. Shorter intervals between the signals increase the time resolution and are particularly well suited for the precise detection of fast changes. At the same time, longer time intervals between the measurement signals make it possible to reduce the energy consumption.

According to one advantageous enhanced embodiment of the invention, the ultrasonic waves in the measurement spectrum and/or in the broadband spectrum are generated by means of a chirp signal, a sweep signal, and/or a multitone signal. As a result, the ultrasonic waves can be generated with the said frequency range and/or with the continuous spectrum.

It is also advantageous when, for determining the bodily function, the ultrasonic waves are generated and detected using the same MEMS sound transducer. This reduces the number of components required and increases the efficiency of the system, which is particularly advantageous for compact, wearable devices such as headphones. Additionally or alternatively, the headphones can include a further MEMS sound transducer and/or a further microphone, by means of which the reflected ultrasonic waves are detected.

It is advantageous when the audible sound waves and the ultrasonic waves are generated by means of the MEMS sound transducer, in particular the same MEMS sound transducer, wherein the audible sound waves are preferably generated at the same time and/or simultaneously with the ultrasonic waves. The possibility to generate both sound types using the same sound transducer reduces the need for separate components and makes a compact design possible, which is advantageous in particular for wearable devices such as headphones.

It is advantageous when audible sound waves are generated by means of the MEMS sound transducer, wherein these are preferably generated at the same time as the ultrasonic waves. Generating audible sound waves and ultrasonic waves at the same time enables the sound transducer to be used in a versatile manner and increases the functionality of the headphones. As a result, the headphones can also be used, for example, for listening to music, and also for measuring the bodily functions at the same time.

According to an advantageous enhanced embodiment of the invention, the bodily function is evaluated by means of an algorithm and/or an evaluation program, wherein the control unit preferably runs the algorithm and/or the evaluation program. The use of algorithms for signal processing increases the accuracy and efficiency of the analysis of cardiac signals and respiratory signals and improves the reliability of the system for continuous monitoring.

The invention relates to the use of an, in particular broadband, MEMS sound transducer for headphones and/or to a method for determining a bodily function. The headphones and/or the method have at least one feature according to the preceding description and/or the following description. Furthermore, the MEMS sound transducer has at least one feature according to the preceding description and/or the following description in order to be used in the headphones and/or according to the method described here.

One property of the broadband ultrasound sensor system is that a system having broadband MEMS sound transducers can generate very short pulses, which are both information-dense and energy-dense. This is due, in particular, to the particular properties of broadband signals.

The Fourier transform has an inverse relationship with pulsed signals. The duration of a pulse, in particular a discrete-time pulse, is inversely proportional to its bandwidth. A broadband MEMS sound transducer can therefore generate pulses that are very short, which makes a high temporal measurement resolution possible.

For the cardiac and/or respiratory monitoring, the mode of operation is based on the following steps. The MEMS sound transducer transmits continuously short, broadband ultrasonic pulses into the ear canal. The sound waves interact with the air volume and the tissues in the ear. When the blood pulses through the vessels in the ear, this results in small motions (volume changes) and changes in the density of the tissue. These changes affect the reflected ultrasonic waves.

The microphone of the headphones, in particular the MEMS sound transducer, which emits the ultrasonic waves, a further microphone, and/or a further MEMS sound transducer, detects the reflected waves and receives these with a high scanning rate, in order to detect the details of the short pulses. The signals are then processed in order to extract these. Algorithms can filter out disturbances and other artifacts in order to determine the heart rate and possible anomalies in the cardiac function and/or the respiratory function, for example, in the heart rate or the respiration rate.

Broadband MEMS sound transducers offer significant advantages for measuring bodily functions. Due to the generation of very short pulses, the signals can be detected with higher resolution, which results in more detailed information regarding the reflected signals. This helps to accurately detect the small and fast changes in the tissue and blood flow. In addition, broadband ultrasonic waves penetrate the tissue to different depths depending on the frequency, which contributes to a richer data acquisition and improves the precision of the heart rate measurement.

The use of a broadband MEMS sound transducer also makes it possible to use signal processing techniques such as frequency range analysis and adaptive filtering, which further increases the ability to extract the pulsing components from data that are susceptible to error. Moreover, the use of a broadband signal results in an improved signal-to-noise ratio (SNR), since the actual pulse signal can be better distinguished from background noise due to the frequency distribution. This improves the clarity and reliability of the measurement of the bodily function. These techniques can extract additional information from the received signals and thus improve the accuracy and reliability of the ToF measurements. Broadband ultrasonic waves also offer the possibility to adaptively compensate for environmental fluctuations, such as changes in temperature and humidity, which affect the sound velocity and, as a result, can impair the accuracy of the propagation-time measurements.

This method is non-invasive and offers comfort during the continuous monitoring, since low sound pressure levels can be used, which avoids potential discomfort for the wearer. Due to the high energy density of the pulses, the sound pressure levels can be limited without sacrificing measurement quality, whereby user friendliness is increased.

The mode of operation is also more resistant to slight changes in position of the sensor, such that consistent and accurate measurements can be ensured even when the device has not been perfectly placed. The high information density generated by broadband ultrasound also improves the calibration process, since more accurate adaptations to individual differences in the ear canal and to tissue properties are possible.

The broadband ultrasound MEMS sound transducer improves the handling of multipath effects (where signals are reflected by a plurality of surfaces), in that direct signal paths can be differentiated from reflected signal paths on the basis of their frequency content. This improves the accuracy of the detection of relative positions in space.

The short duration of the pulses enables the system to generate sharper and more detailed images. Short pulses also mean a smaller pulse width in relation to the distance, which contributes to the resolution of smaller features and motions.

Broadband ultrasound signals are also less susceptible to interferences and disturbances in comparison to narrow-band signals, which increases the clarity of the received signal-a decisive advantage for the precise measurement of the propagation time.

Broadband MEMS sound transducers offer high resolution and accuracy for time-of-flight applications. An improved handling of multipath effects and reflection effects, higher signal quality, more precise temporal and spatial resolution, better material interaction, and advanced signal processing possibilities collectively improve the ability of the system to accurately detect gestures, measure distances, and characterize objects in different environments.

A broadband MEMS sound transducer can generate ultrasonic waves in a broad frequency range. This means that the sound transducer emits not only one single established frequency, but rather outputs sound waves beyond a spectrum, in particular a continuous spectrum-for example, of at least 20 kHz to 40 kHz or to 60 kHz or to 80 kHz or to 100 kHz. This spectrum can be a continuous spectrum, in particular in the measurement spectrum. This plurality of frequencies, or the continuous frequency spectrum, improves the resolution of the signals, since different frequencies penetrate the tissue to different depths or are reflected by different surfaces in a different manner. This allows finer details to be detected and analyzed, which is helpful, in particular, for monitoring the cardiac functions or the respiratory functions.

A short pulse in the ultrasonic range makes it possible to exactly detect and analyze fast changes in the body, such as the heart rate. Due to the plurality of frequencies, the reflection signals become more information-rich, which increases the accuracy, for example, of the measurement of the heart rate or the respiration rate. In addition, due to the bandwidth of the signal, the background noise (i.e. disturbing noise) is reduced, whereby the actual signal can be more easily and reliably detected.

A broadband MEMS sound transducer is also more resistant to slight changes in position of the sensor. Even if the headphones or the headset slips slightly in the ear, the sound transducer can still carry out precise measurements. This is a great advantage specifically for wearable devices, since the device does not need to be exactly positioned in order to deliver accurate results. In addition, the additional variety of data can help to adapt the device to individual differences in the ear canal of the user and thus ensure better calibration and accuracy.

Another advantage of the invention is the use of a maximum-length-sequence signal for determining at least one feature of a wearer and/or for authentication, wherein the maximum-length-sequence signal is preferably designed and/or generated according to the preceding description and/or the following description. The maximum-length-sequence signal is used for the method according to the preceding description and/or the following description. The technical advantage of the use is that the MLS signal is usable regardless of the anatomy and the arrangement of the device in the ear canal, whereby calibration methods are dispensed with. With the aid of the MLS signal, the emitted sound waves can be generated, by means of which the measurement, or the determination, is carried out.

The maximum-length-sequence signal (MLS) is a deterministic, pseudorandom digital signal defined by a bitstream generated by means of a linear feedback-shift register (LFSR). This shift register generates a sequence having a maximum period length of 2\hat{ }n−1, wherein n is the number of bits of the register.

The number of bits is preferably in the range from 8 to 16, whereby a balanced relationship between signal resolution, period duration, and computational complexity is achieved.

The MLS signal consists of a time-dependent sequence of discrete values that assume two states, typically 0 and 1. For the digital further processing, the signal is converted into a symmetrical shape, in which the values are centered around the zero point, for example, −1 and +1. This allows for the mathematically stable application of digital filters and the linear signal processing in flow-command representation. Each value of the signal is output at a fixed time interval which is determined by the scanning rate. Typical scanning rates are between 50 kHz and 200 kHz, preferably 96 kHz, whereby a usable frequency range up to 48 KHz is obtained.

The maximum-length-sequence signal is distinguished by a flat frequency spectrum. It has a nearly uniform spectral energy density over the entire utilized frequency range. As a result, all frequency components are excited at the same time and with the same energy, which enables the transmission function of a system to be detected completely and at the same time. The autocorrelation function of the MLS signal yields, approximately, a Dirac pulse, or a Kronecker Delta function. By cross-correlation of the emitted signal and the received signal, the pulse response of the system can therefore be precisely reconstructed. This property is particularly advantageous for broadband measuring methods, since the complete system response can be determined in one single measurement cycle.

The digital MLS signal is filtered for adaptation to the particular measurement scenario. The filtering is preferably carried out by means of a digital filter unit, which adapts the signal in a frequency-selective manner and optimizes this for the measuring range. The filter unit can include a combination of high-pass filters, low-pass filters, and band-pass filters, which are connected in cascade or in parallel. Preferably, digital Butterworth filters having flat amplitude characteristics or biquad filter structures having adjustable edge steepness and damping are used. These filter structures ensure low-loss and phase-stable signal processing.

The filtering is used, in particular, to delimit the frequency spectrum of the signal to the desired operating range. Audible frequencies are removed, such that the signal is shifted into the ultrasonic range. The lower cutoff frequency range can be between 20 kHz and 75 kHz, whereas the upper cutoff frequency is preferably set between 40 kHz and 100 kHz. As a result, the acoustic transmitted signal become inaudible to the user, whereas, at the same time, high spectral resolution and measurement precision are achieved. The resulting waveform is a smoothed, continuous digital transmitted signal having uniform energy distribution over the desired frequency range.

In addition to the band delimitation, the filter unit can carry out a frequency-dependent predistortion of the signal in order to compensate for the non-linear frequency response and the frequency-dependent sensitivity of the electroacoustical converter, in particular of loudspeaker and microphone. As a result, a linearization of the overall transmission function of the system is achieved, which increases the accuracy of the pulse-response determination. The digital transmitted signal generated by the filter unit has a smoothed, nearly sinusoidal structure and can be converted into an analog electrical transmitted signal using a digital-to-analog converter. This is then emitted as an acoustic signal by a sound transducer unit, for example a MEMS sound transducer unit. The filtered MLS signal remains deterministic and periodic despite the smoothing, such that it is still unambiguously identifiable for the cross-correlation analysis.

A significant technical advantage of the maximum-length-sequence signal is that it is a broadband, calibration-free, and robust excitation signal. Since all frequencies are excited at the same time and uniformly, there is no need for individual calibration to the user or to the geometry of the ear canal. Anatomical differences or changes in position of the device only affect the shape of the measured pulse response, without impairing the method.

Moreover, the MLS signal distributes unavoidable intermodulation distortions over a broad spectrum. These distortion products are therefore below the hearing threshold and are not critical for the measurement. As a result, a high immunity to interference is achieved and the signal remains precisely evaluatable even during non-linear system behavior.

The mathematical structure of the signal also enables efficient implementation. The MLS can be generated in software or hardware with low computational complexity and, as a result, is suitable for embedded systems having limited resources. The repetition of the signal after each period length allows continuous measurement over time, during which changes in the pulse response or in the frequency response can be detected in real time.

The maximum-length-sequence signal is therefore a suitable excitation signal for broadband measuring methods, in particular for determining transmission functions, pulse responses, and physiological or biometric features. It combines high spectral coverage, reproducibility, robustness, and freedom from calibration in one single deterministic signal principle.

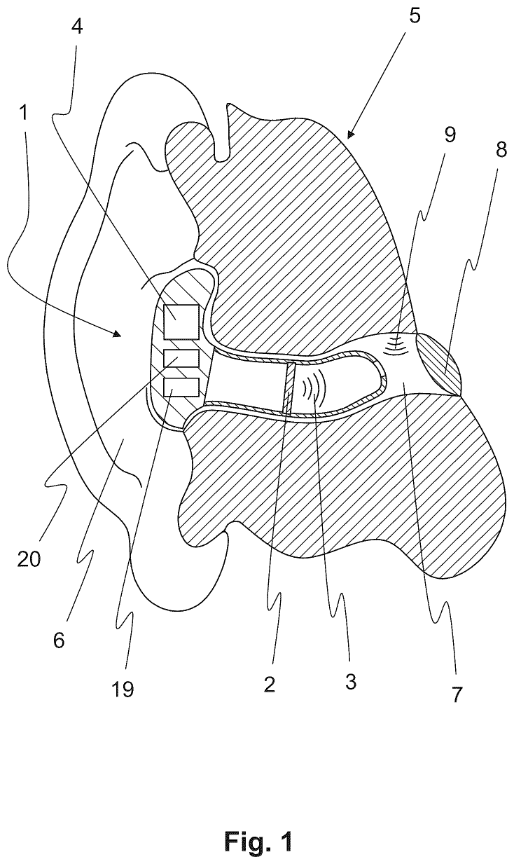

Further advantages of the invention are described in the following exemplary embodiments. Wherein:
FIG. 1 shows a schematic sectional view of headphones in the form of in-ear headphones having a MEMS sound transducer,

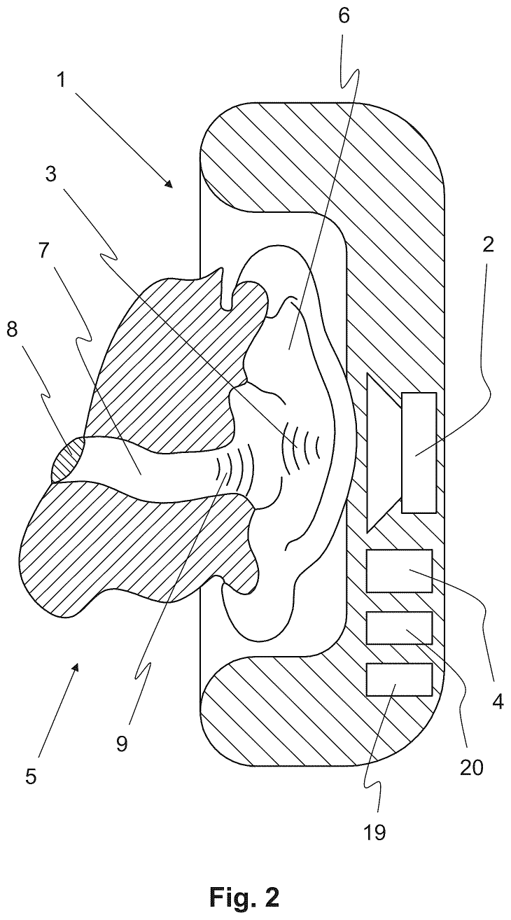

FIG. 2 shows a schematic sectional view of headphones in the form of over-ear headphones, or on-ear headphones, having a MEMS sound transducer,

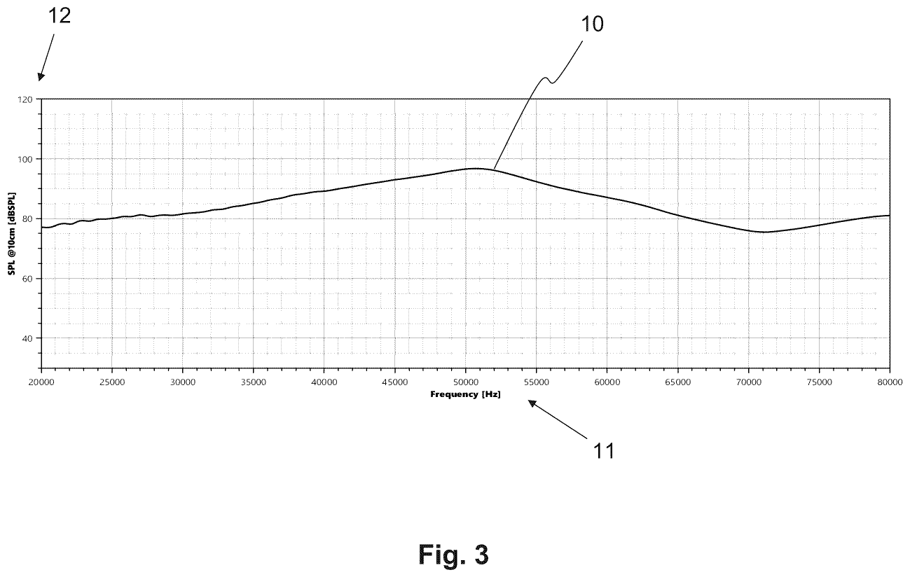

FIG. 3 shows an exemplary broadband spectrum in the ultrasonic range of a broadband MEMS sound transducer,

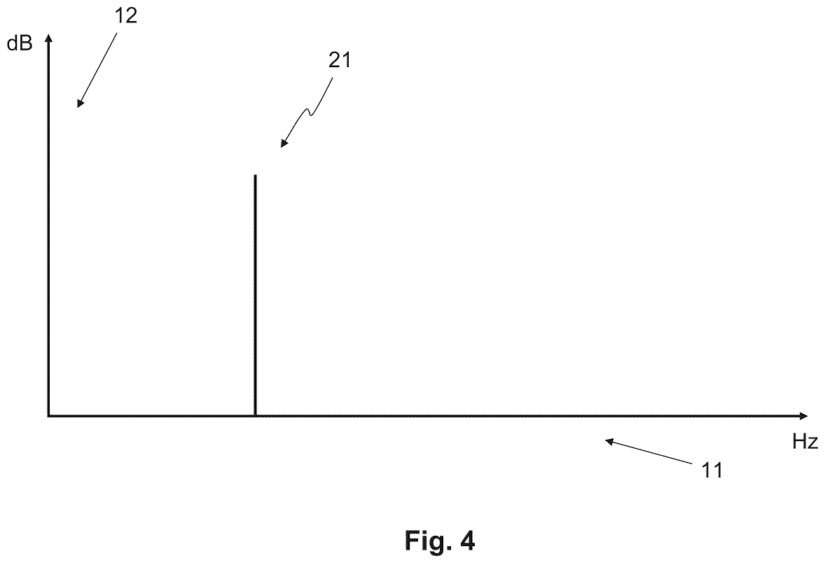

FIG. 4 shows an exemplary measurement signal emitted from the broadband MEMS sound transducer for measuring the bodily function, wherein the measurement signal is a frequency peak,

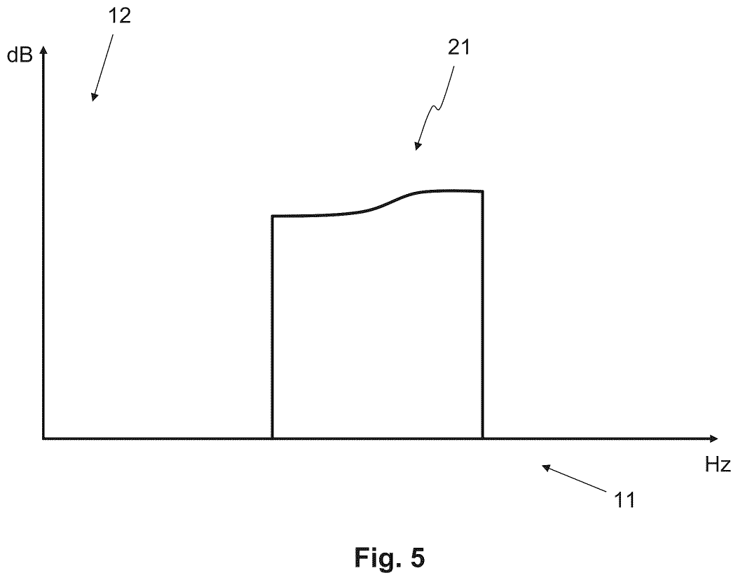

FIG. 5 shows an exemplary measurement signal emitted from the broadband MEMS sound transducer for measuring the bodily function, wherein the measurement signal is a broad frequency spectrum,

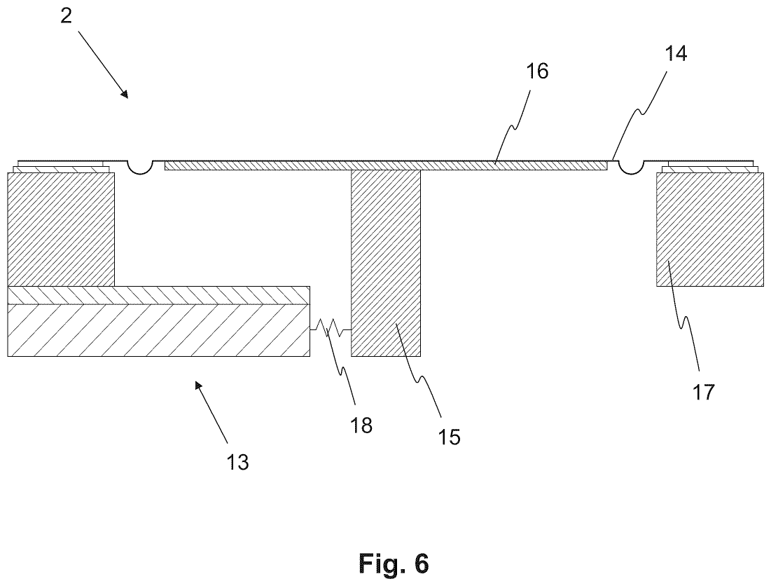

FIG. 6 shows a schematic sectional view of a MEMS sound transducer having a piezoelectric element which is coupled to a diaphragm,

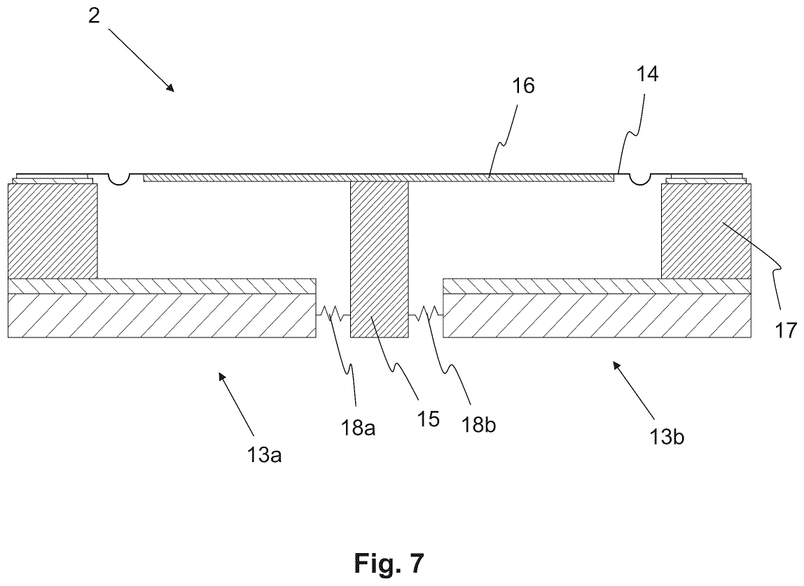

FIG. 7 shows a schematic sectional view of a MEMS sound transducer having two piezoelectric elements, both of which are coupled to the diaphragm.

The exemplary embodiment shown in FIG. 1 shows headphones 1 in the form of in-ear headphones, which are arranged in an ear 6 of a wearer 5. The headphones 1 are at least partially inserted into an ear canal 7 in this case. The headphones 1 include a sound transducer 2, which is a MEMS sound transducer 2 and is used to generate and detect ultrasonic waves 3. The sound transducer 2 is arranged in such a way that the generated ultrasonic waves 3 are emitted into the ear canal 7 of the ear 6.

As is apparent from the exemplary embodiment in FIG. 1, the headphones 1 include a control unit 4, which processes the detected ultrasonic waves 3 in order to determine bodily functions of the wearer 5. These bodily functions are, for example, the cardiac and respiratory functions, which are detected by analyzing the ultrasonic waves 9 reflected by tissue structures.

The headphones 1 also include a signal generator 19, which can generate different waveforms such as chirp signals, sweep signals, or multitone signals, which are used to form the ultrasonic waves 3. With the aid of these waveforms, ultrasonic waves 3 having, for example, a continuous spectrum, can be generated.

According to FIG. 1, the sound transducer 2 is designed in such a way that it can generate sound waves 3 from a broadband spectrum 10. The broadband spectrum 10 can extend, for example, over a frequency range from 3 kHz to 80 kHz. This broad frequency coverage offers the advantage that different frequencies can be used for measurement. The use of the broadband spectrum 10 can improve the signal-to-noise ratio.

Additionally or alternatively, the headphones 1 can form ultrasonic waves 3 having a sound pressure level 12 in the range of the broadband spectrum 10 which is preferably between 50 dB and 80 dB. This delimitation of the sound pressure level 12 contributes to the stability of the measurements and ensures comfortable use by minimizing the load on the hearing.

The headphones 1 shown here also include a modulator 20. With the aid of the modulator 20, sound waves 3 can be simultaneously generated in the audible frequency spectrum, i.e. audible sound waves 3, and in the ultrasonic spectrum, i.e. ultrasonic waves 3. The modulator 20 can combine the corresponding electrical signals, or modulate these together, such that, on the basis thereof, the MEMS sound transducer 2 generates the audible sound waves and the ultrasonic waves 3. It is therefore possible to listen to music and carry out the measurement of the bodily function at the same time.

The exemplary embodiment shown in FIG. 2 shows headphones 1 designed as over-ear headphones or on-ear headphones. The headphones 1 include a MEMS sound transducer 2, which is provided for generating and detecting ultrasonic waves 3. These ultrasonic waves 3 are emitted into the ear canal 7 of the ear 6 of a wearer 5, whereby it is possible to detect the reflections of these waves on tissue structures. The reflected ultrasonic waves 9 are detected by the sound transducer 2 and made available for further analysis.

As is apparent in FIG. 2, a control unit 4 is integrated into the headphones 1. This control unit 4 is used to evaluate the ultrasonic waves 9 reflected by the tympanic membrane 8 and/or the surrounding tissue structures. As a result, it becomes possible to monitor bodily functions, in particular the cardiac and respiratory functions, of the wearer 5. The use of ultrasonic waves 3 to determine these vital parameters makes it possible to precisely detect small changes in tissue and in blood flow, thereby supporting a detailed analysis of the cardiac signals and the respiratory signals.

The headphones 1 also include a signal generator 19 which can generate different types of signals, such as chirp signals and sweep signals. With the aid of these signals, measurement signals 21 can be generated by means of the ultrasonic waves 3. Additionally or alternatively, the measurement spectrum can have a sound pressure level 12 having a deviation of +/−10 dB, in particular +/−5 dB. This improves the detection of changes in blood flow and the tissue motions, which is advantageous, in particular, for reliably monitoring the cardiac function and the respiratory function.

The MEMS sound transducer 2 is also designed in such a way that it can generate ultrasonic waves 3 in the broadband spectrum 10. Such a broadband spectrum 10 increases the flexibility in signal processing and enables differentiated detection of different tissue structures by means of different measurement frequencies. This improves the detection of smaller motions and ensures a higher measurement accuracy.

Additionally or alternatively, the headphones 1 are designed in such a way that the generated ultrasonic waves have a sound pressure level 12 that is preferably between 50 dB and 80 dB. This delimitation of the sound pressure level 12 contributes to the stability of the measurements and minimizes the load on the hearing, which increases the wearing comfort for the wearer 5 and makes it possible to use the headphones 1 for a longer period of time.

The exemplary embodiment from FIG. 2 therefore shows headphones 1 which are equipped with ultrasound technology and a control unit 4 in order to precisely detect the vital functions of the wearer 5. The combination of broadband ultrasound and an optimized sound pressure level 12 offers a reliable approach to the continuous monitoring of the bodily functions of the wearer 5.

FIG. 3 shows an exemplary broadband spectrum 10 which is generatable by means of the MEMS sound transducer 2. The frequency 11 in hertz (Hz) is indicated on the horizontal axis, whereas the sound pressure level 12 in decibles (dBSPL=sound pressure level in dB) is indicated on the vertical axis. The broadband spectrum 10 shown here extends from approximately 20 kHz to 80 kHz in this example. With the aid of the MEMS sound transducer 2, in particular, lower frequencies 11 can also be generated. The broadband spectrum 10 can also extend down to 3 kHz, such that not only ultrasonic waves 3, but also audible sound waves 3 can be generated.

The coverage of a broad frequency range, in particular in the range from 3 kHz to 80 kHz, offers advantages in detecting different tissue types and provides a higher resolution of the measured data.

Such a broadband spectrum 10 improves the ability to adapt the measurement of the bodily function to different wearers 5 of the headphones 1. Different wearers 5 of the headphones 1 also have different shapes of the ear canals 7. The different shapes of the ear canals 7 can be responded to by selecting a different measurement frequency from the broadband spectrum 10 which is particularly well suited for the specific shape of the ear canal 7. The headphones 1 can also be arranged in a way other than that shown in FIGS. 1 and 2. Especially when playing sports, it may happen that the headphones 1 shift. It is then possible that the measurement frequency with which the ultrasonic waves 3 are emitted for performing a measurement does not deliver an optimal measurement result. Due to the MEMS sound transducer 2, it is possible to use a plurality of measurement frequencies from the broadband spectrum 10 to carry out the measurement.

A sound pressure level 12 which the sound waves 3 generatable by the MEMS sound transducer 2 can have is also shown here. According to this FIG. 3, the sound waves 3 have a sound pressure level 12 of at least 50 dB, preferably also greater than or equal to 70 dB and less than or equal to 100 dB or less than or equal to 90 dB, such that sufficient signal quality is ensured.

The broadband spectrum 10 of a MEMS sound transducer 2 shown in FIG. 3 shows the bandwidth of the frequency 11 and the sound pressure level 12 in the ultrasonic range, which extends from approximately 20 kHz to 80 KHz. The MEMS sound transducer 2 can generate the sound waves 3 in this broad frequency range, or broadband spectrum 10, whereby it becomes possible to precisely detect tissue and blood reflections, which are relevant for monitoring vital parameters such as the cardiac function and the respiratory function. The flexible use of the broadband spectrum 10 is particularly advantageous, since the measurement frequencies used can be matched to specific measurement requirements.

The broad coverage of the ultrasonic range enables flexible frequency adaptation and/or selection of the measurement frequency for the measurements and can help to detect different tissue structures, which is advantageous, in particular, in the ear canal 7 of the wearer 5. In addition, the possibility to select the measurement frequency from the broadband spectrum 10 improves the signal-to-noise ratio. The measurement frequency that is optimal for the measurement can be selected from the broadband spectrum 10, wherein the selection of the measurement frequency depends on the anatomy of the wearer 5 and the arrangement of the headphones 1.

The continuous broadband spectrum 10 shown here can be generated with the aid of the MEMS sound transducer 2.

The two FIGS. 4 and 5 each show measurement signals 21 by means of which the bodily function can be determined.

FIG. 4 shows a measurement signal 21 with a measurement frequency which has a measurement frequency peak. This means that, as the measurement signal 21, ultrasonic waves 3 having a specific frequency 11 are emitted. The measurement signal 21 of the two FIGS. 4 and 5 is schematically shown. This measurement signal 21 also has a certain width, of course, which can be, for example, 3 kHz. During the generation of this measurement signal 21, other ultrasonic waves 3 having other frequencies 11 are also generated, which ultrasonic waves have a lower sound pressure level 12, however. This measurement signal 21 shown in FIG. 4 can have, for example, a measurement frequency of 30 kHz. These 30 kHz can be matched to a certain anatomy of the wearer 5 and/or to a certain wearing arrangement of the headphones 1. On another wearer 5 of the headphones 1, the measurement signal 21 can have, for example, 38.5 kHz, since the anatomy is different. The measurement signal 21 emitted from the MEMS sound transducer 2 can also have a plurality of measurement frequencies with corresponding measurement frequency peaks. As a result, a plurality of measurements can be carried out at the same time.

FIG. 5 shows the measurement signal 21 which has a measurement frequency spectrum. With the aid of the MEMS sound transducer 2, the measurement signal 21 shown in FIG. 5, which has a broad measurement frequency spectrum, is emitted for measuring the bodily function. For example, the measurement signal 21 extends from 20 kHz to 45 kHz. By means of this broad measurement frequency spectrum, a plurality of information and/or measurements can be carried out at the same time.

As is apparent in FIG. 5, the measurement signal 21 has a continuous measurement frequency spectrum, such that the various information and/or measurements can be achieved. Furthermore, the measurement signal 21 having the measurement frequency spectrum shown here can have a sound pressure level 12 which has a deviation of +/−10 dB, in particular +/−5 dB. The measurement signal 21 shown here in FIG. 5 can also be adapted, in terms of the frequency 11, to the wearer 5. Only one measurement signal 21 is shown in FIG. 5. Alternatively, the measurement can also be carried out using a plurality of measurement signals 21, each of which has a measurement frequency spectrum.

In order to adjust and/or select the optimal frequency 11 of the measurement signal 21, the control unit 4 can run, for example, a search program and/or a search algorithm. This can try out and evaluate, for example, different measurement frequencies of the measurement signal 21. The control unit 4 can then select the optimal measurement frequency of the measurement signal 21, at which the best results are obtained. For example, the control unit 4 can select the measurement frequency that has the greatest signal-to-noise ratio.

The exemplary embodiment shown in FIG. 6 shows a schematic sectional view of a MEMS sound transducer 2 which includes a piezoelectric element 13 which is coupled to a diaphragm 14. The piezoelectric element 13 is used to generate vibrations, which are output by the diaphragm 14 as ultrasonic waves 3. This arrangement makes it possible to efficiently generate high-frequency sound waves 3, which can be used to precisely detect bodily functions, such as cardiac and respiratory signals.

As is apparent from FIG. 6, the diaphragm 14 is connected to the piezoelectric element 13 via an amplification plate 16. The amplification plate 16 ensures that the vibrations of the piezoelectric element 13 are uniformly transmitted to the diaphragm 14. As a result, the diaphragm 14 can be deflected in a planar manner, which enables uniform and stable emission of the ultrasonic waves 3. The amplification plate 16 therefore improves the sound emission quality and contributes to an increase in the efficiency and range of the MEMS sound transducer 2. The planar deflection can also generate the broadband ultrasonic waves 3.

Furthermore, the piezoelectric element 13 is connected to the coupling element 15 by means of a spring element 18.

Furthermore, the sound transducer 2 is arranged on a support unit 17, which forms a stable base for the overall system and holds the components, such as the piezoelectric element 13, the diaphragm 14, the amplification plate 16, and the spring element 18, in a fixed position.

The embodiment of the MEMS sound transducer 2 shown in FIG. 6 therefore shows a compact and efficient design in which the interaction between piezoelectric element 13, diaphragm 14, amplification plate 16, spring element 18, and support unit 17 makes high sound power and precise signal transmission possible. The combination of these components ensures an improved signal quality and the ability to generate a uniform, continuous, and/or stable ultrasonic spectrum, which is advantageous for the continuous monitoring of vital parameters of the wearer 5 of the headphones 1.

The exemplary embodiment shown in FIG. 7 shows a schematic sectional view of a MEMS sound transducer 2 which includes at least two piezoelectric elements 13a and 13b, each of which is coupled to the common diaphragm 14. The arrangement of the two piezoelectric elements 13a and 13b enables symmetric excitation of the diaphragm 14, which results in a uniform and stable emission of the generated ultrasonic waves 3.

The diaphragm 14 is connected to the piezoelectric elements 13a and 13b via an amplification plate 16. The amplification plate 16 ensures that the vibrations of the piezoelectric elements are uniformly transmitted to the diaphragm 14 and amplified.

A spring element 18 is provided between each of the piezoelectric elements 13a and 13b and the coupling element 15. Each piezoelectric element 13a, 13b is connected to the coupling element 15 by means of a spring element 18.

The ultrasonic waves 3 can be generated and/or detected with the aid of the MEMS sound transducer 2 shown in FIGS. 6 and 7. For example, the ultrasonic waves 3 and the reflected ultrasonic waves 9 can be detected using the same MEMS sound transducer 2. The headphones 1 can also include at least two MEMS sound transducers 2, however, such that the ultrasonic waves 3 are generated using a first MEMS sound transducer 2 and the reflected ultrasonic waves 9 are detected using a second MEMS sound transducer 2. The audible sound waves can also be generated with the aid of at least one MEMS sound transducer 2, such that, for example, music can be played back. Since the ultrasonic waves 3 are not audible, the determination of the bodily function can be carried out in parallel with the playback of music or the like.

### LIST OF REFERENCE CHARACTERS

1 headphones
2 sound transducer / MEMS sound transducer
3 sound waves / ultrasonic waves
4 control unit
5 wearer
6 ear
7 ear canal
8 tympanic membrane
9 reflected ultrasonic waves
10 broadband spectrum
11 frequency
12 sound pressure level
13 piezoelectric element
14 diaphragm
15 coupling element
16 amplification plate
17 support unit
18 spring element
19 signal generator
20 modulator
21 measurement signal

1. Headphones (1), in particular on-ear headphones, over-ear headphones, and/or in-ear headphones, comprising at least one sound transducer (2) for generating and detecting at least ultrasonic waves (3), and comprising a control unit (4) which can determine at least one feature, in particular a bodily function, preferably a cardiac function, a respiratory function, and/or an identity, of a wearer (5) of the headphones (1), and/or carry out an authentication of the wearer (5), on the basis of the generated and detected ultrasonic waves (3),
characterized in that
the at least one sound transducer (2) is a MEMS sound transducer (2) which can generate at least ultrasonic waves (3) in a broadband spectrum (10).

2-33. (canceled)
